(19) United States
(12) Patent Application Publication
(10) Pub. No.: US 2005/0128763 A1
(43) Pub. Date: Jun. 16, 2005

(54) Incandescent lamp for vehicle headlights

(75) Inventors: Christian Seichter, Herbrechtingen (DE); Klaus Wittmann, Sontheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN, DE (US)

(21) Appl. No.: 11/006,779

(22) Filed: Dec. 8, 2004

(30) Foreign Application Priority Data
Dec. 12, 2003 (DE) 103 58 677.6
Dec. 16, 2003 (DE) 103 59 152.4

(51) Int. Cl. F21K 2/00; F21V 1/00

(52) U.S. Cl. 362/509

(57) ABSTRACT

An incandescent lamp for vehicle headlights has at least one incandescent filament and a shading apparatus for the at least one incandescent filament, which are both arranged in a lamp vessel. The shading apparatus has a tab in the form of a hook which is integrally formed on an edge, which runs transversely to the filament axis of the at least one incandescent filament, of the shading apparatus and which is connected to an outgoing filament line of the at least one incandescent filament.

### I. TECHNICAL FIELD

The invention relates to an incandescent lamp for vehicle headlights, the incandescent lamp having at least one incandescent filament and a shading apparatus for the at least one incandescent filament, which are arranged in a lamp vessel. In particular, the invention relates to a two-filament halogen incandescent lamp for motor vehicle headlights.

### II. BACKGROUND ART

An incandescent lamp of this type is disclosed, for example, in the patent application DE 195 44 012. This patent application describes a two-filament halogen incandescent lamp for a motor vehicle headlight having two incandescent filaments and a shading apparatus, which are arranged in the lamp vessel. One of the incandescent filaments, which is referred to as the secondary filament, generally serves the purpose of producing the low beam, whereas the other incandescent filament, which is referred to as the main filament, generally serves the purpose of producing the high beam. The secondary filament is arranged close to the shading apparatus, so that its light is partially shaded by the shading apparatus. One outgoing filament line of the secondary filament is threaded through an aperture in the shading apparatus and welded to a power supply wire. The aperture may result in the diffused light component being increased in an undesirable manner.

### III. DISCLOSURE OF THE INVENTION

It is the object of the invention to provide a generic incandescent lamp with an improved means of suspending the incandescent filament, which is arranged close to the shading apparatus.

This object is achieved according to the invention by an incandescent lamp for vehicle headlights, the incandescent lamp having at least one incandescent filament and a shading apparatus for the at least one incandescent filament, which are arranged in a lamp vessel, wherein said shading apparatus has a tab in the form of a hook which is integrally formed on an edge, which runs transversely to the filament axis of said at least one incandescent filament, of the shading apparatus and which is connected to an outgoing filament line of the at least one incandescent filament. Particularly advantageous refinements of the invention are described in the dependent patent claims.

The incandescent lamp according to the invention has at least one incandescent filament and a shading apparatus for the at least one incandescent filament, which are arranged in a lamp vessel, the shading apparatus having a tab in the form of a hook which is integrally formed on an edge, which runs transversely to the filament axis of the at least one incandescent filament, of the shading apparatus and which is connected to an outgoing filament line of the at least one incandescent filament. The abovementioned measures ensure improved suspension of the incandescent filament, since the outgoing filament line connected to the shading apparatus does not cause any light shading, and the tab in the form of a hook makes possible a secure connection between the outgoing filament line and the shading apparatus.

The shading apparatus and the tab in the form of a hook are preferably formed from a metal sheet. As a result, the tab can be produced as part of the shading apparatus as early as during manufacture of the shading apparatus.

The outgoing filament line, connected to the tab, of the at least one incandescent filament is advantageously surrounded by a metal film made of molybdenum or tantalum in order to ensure a good welded connection. The molybdenum or tantalum metal film can be welded more effectively to the shading apparatus, which is preferably made of sheet molybdenum, or to the tab of the shading apparatus than the tungsten outgoing filament line of the incandescent filament.

### IV. BRIEF DESCRIPTION OF THE DRAWINGS

The invention is explained in more detail below with reference to two preferred exemplary embodiments. In the drawing:

FIG. 1 shows the suspension of an incandescent filament in an incandescent lamp in accordance with the preferred exemplary embodiment of the invention,

FIG. 2 shows a side view of a two-filament halogen incandescent lamp to which the invention may be applied.

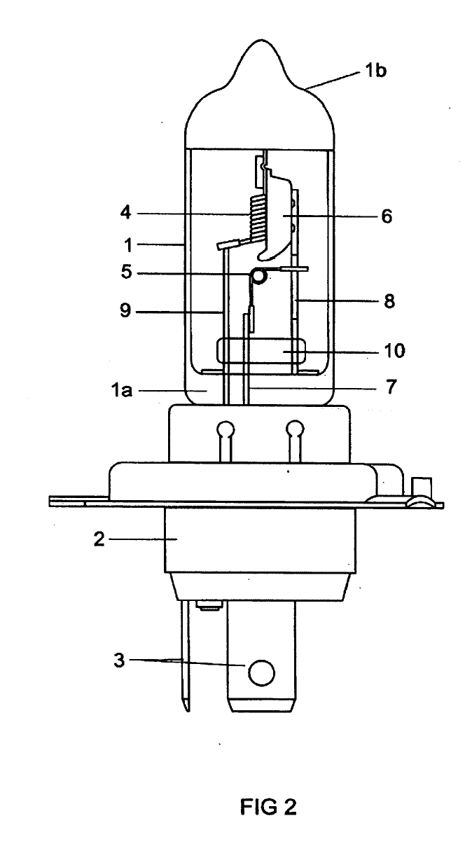

### V. BEST MODE FOR CARRYING OUT THE INVENTION

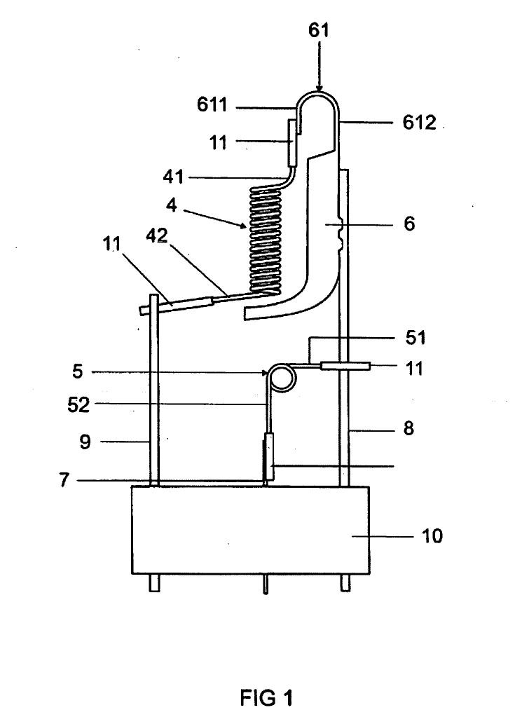

The preferred exemplary embodiment of the invention is a two-filament halogen incandescent lamp which is envisaged to be used in motor vehicle headlights. This lamp has two incandescent filaments 4, 5 and a shading device 6, which are enclosed in an essentially cylindrical, hard-glass or silica-glass lamp vessel 1. The first incandescent filament 4, which is also referred to as the secondary filament, serves the purpose of producing the low beam and is arranged close to the shading device 6, which partially shades the light emitted by the secondary filament 4. The second incandescent filament 5, which is also referred to as the main filament, serves the purpose of producing the high beam. The lamp vessel 1 has a sealed-off end 1a, which is fixed in the lamp base 2. The dome 1b of the lamp vessel 1 is provided with a light-absorbing, black or silver-colored coating. The circular-cylindrical, transparent region of the lamp vessel 1 may optionally be provided with a transparent blue or bluish coating in order to increase the color temperature of the light emitted by the lamp to approximately 4000 kelvin. The lamp base 2 has three contact lugs 3, which are each electrically conductively connected to the incandescent filaments 4, 5 via a power supply line 7, 8, 9. The power supply lines 7, 8, 9 are embedded in the sealed-off end 1a of the lamp vessel 1 in a gas-tight manner. The silica-glass bar 10 serves the purpose of fixing the power supply wires 7, 8, 9 during the assembly of the lamp mount 4, 5, 6, 7, 8, 9. Details of the suspension, according to the invention, of the incandescent filament are illustrated in FIG. 1.

The first outgoing filament line 41 of the secondary filament 4 is surrounded by a molybdenum film 11 which is welded to the free limb 611 of the tab 61 in the form of a hook which is integrally formed on the shading device 6. The free limb 611 extends parallel to the filament axis and parallel to the first outgoing filament line 41 of the secondary filament 4. The other limb 612 of the tab 61 in the form of a hook is integrally formed on an edge, which runs transversely to the filament axis of the secondary filament 4, of the shading device 6. The tab 61 in the form of a hook has approximately the shape of the letter U, is integral with the shading device 6 and is made, as is the shading device 6, of sheet molybdenum. The width of the tab 61 is 2 mm and its thickness corresponds to the thickness of the molybdenum sheet from which the shading device 6 is produced. That surface of the shading device 6 which faces away from the secondary filament 4 is welded to the power supply wire 8. The second outgoing filament line 42 of the secondary filament 4 is surrounded by a molybdenum film 11 and welded to the power supply line 9. The first outgoing filament line 51 of the main filament 5 has a molybdenum film 11 wound around it and is welded to the power supply line 8, whereas its second outgoing filament line 52, which likewise has a molybdenum film 11 wound around it, is welded to the power supply line 7.

The invention is not limited to the exemplary embodiments explained in more detail above. The free limb 611 of the tab 61 in the form of a hook need not necessarily run parallel to the outgoing filament line 41 of the incandescent filament 4, but may instead also be arranged transversely thereto. The tab 61, rather than being U-shaped, may also be bent into a hook in some other way. The two incandescent filaments 4, 5 do not necessarily have to have single-coil, light-emitting sections 43 and uncoiled outgoing filament lines, but instead may also have twin-coil, light-emitting sections and single-coil outgoing filament lines. In addition, the molybdenum films 11 may be dispensed with, if desired. The molybdenum films 11 only act as a welding aid since they can be welded more effectively to the likewise molybdenum power supply wires 7, 8, 9 than the tungsten outgoing filament lines of the incandescent filaments 4, 5.

1. An incandescent lamp for vehicle headlights, the incandescent lamp having at least one incandescent filament and a shading apparatus for the at least one incandescent filament, which are arranged in a lamp vessel, wherein said shading apparatus has a tab in the form of a hook which is integrally formed on an edge, which runs transversely to the filament axis of said at least one incandescent filament, of said shading apparatus and which is connected to an outgoing filament line of said at least one incandescent filament.

2. The incandescent lamp as claimed in claim 1, wherein the shading apparatus and the tab in the form of a hook are formed from a metal sheet.

3. The incandescent lamp as claimed in claim 1, wherein the outgoing filament line, connected to the tab in the form of a hook, is surrounded by a metal film made of molybdenum or tantalum.
